(19) United States
(12) Patent Application Publication
(10) Pub. No.: US 2020/0173580 A1
(43) Pub. Date: Jun. 4, 2020

(54) SEAL ARRANGEMENT

(71) Applicant: VAT Holding AG, Haag (CH)

(72) Inventors: Marco SANDECK, Buchs (CH); Michael ZICKAR, Englburg (CH)

(73) Assignee: VAT Holding AG, Haag (CH)

(21) Appl. No.: 16/638,606

(22) PCT Filed: Jul. 30, 2018
(86) PCT No.: PCT/EP2018/070625

§ 371 Date: Feb. 12, 2020

(30) Foreign Application Priority Data
Aug. 16, 2017 (AT) A331/2017

(51) Int. Cl. F16K 51/02; F16K 1/36; F16K 1/46

(52) U.S. Cl. CPC F16K 51/02; F16J 15/022; F16K 1/465; F16K 1/36

(57) ABSTRACT

In a seal arrangement for sealing first and second components of a vacuum device to one another using an elastomeric sealing material arranged on one of the two components and interacts with a sealing surface arranged on the other component, in a sealed state of the components, the first component is pressed onto the second component by a pressing-on force which acts in a pressing-on direction. The first component has a carrying portion and a bending portion. The elastomeric sealing material is arranged on the bending portion and the sealing surface is arranged on the second component, or vice versa. The thickness of the bending portion, for the case that the elastomeric sealing material is arranged on the bending portion without accounting for the elastomeric sealing material is less than one third of the thickness of the carrying portion and less than one fifth of the length of the bending portion. The bending portion is formed in one piece with the carrying portion and the elastomeric sealing material has a maximum thickness of less than 0.8 mm.

### TECHNICAL FIELD

The invention relates to a seal arrangement for sealing first and second components of a vacuum device in relation to each other using an elastomeric sealing material, which is arranged on one of the two components and interacts with a sealing surface arranged on the other of the two components, wherein, in a sealed state of the first and second components, the first component is pressed onto the second component with a pressing-on force which acts in a pressing-on direction, and the sealing material bears on the sealing surface in a contact region, and, in a separated state of the first and second components, the elastomeric sealing material is spaced apart from the sealing surface, wherein the first component has a carrying portion and a bending portion, and the elastomeric sealing material is arranged on the bending portion and the sealing surface is arranged on the second component, or the sealing surface is arranged on the bending portion and the elastomeric sealing material is arranged on the second component, and a thickness of the bending portion measured in the pressing-on direction, in the case of the elastomeric sealing material being arranged on the bending portion without taking into account the elastomeric sealing material, is less than one third of a thickness of the carrying portion measured in the pressing-on direction, wherein the thickness of the bending portion measured in the pressing-on direction is, over its entire extent, less than one fifth of the length of the bending portion, wherein the length of the bending portion is measured in a longitudinal central section through the seal arrangement, this central section being parallel to the pressing-on direction.

### BACKGROUND

Seal arrangements for sealing components of vacuum devices in relation to each other are used, for example, in vacuum valves. In many types of known vacuum valves, an elastomeric sealing material is arranged on a movably mounted closure member. In the closed state of the vacuum valve, the latter is pressed onto a sealing surface of a valve seat of the valve housing. The seal made of the elastomeric sealing material can be an O-ring, which is arranged in a groove of the closure member. The elastomeric sealing material can also be vulcanized onto the closure member. Such seal arrangements, which are closed and opened during operation, are also referred to as dynamic seals. Static seals are seal arrangements that are permanently closed during regular operation of the vacuum device. For example, these can include a housing seal of a vacuum valve or a seal arrangement for sealing two parts of a valve chamber.

In addition to seal arrangements in which an elastomeric sealing material is used for the sealing, whole-metal seals are known, in which case sealing takes place directly by metal-on-metal contact. Such whole-metal seals are known, for example, as dynamic seals in vacuum valves. A disadvantage among others is that a higher sealing force is needed, and there is a relatively high degree of particle production upon closure of the seal. Whole-metal seals are also used in static seals, for example in the form of flat seals which are fitted between two flanges, in which case a new flat seal has to be inserted upon each closure.

In seal arrangements that make use of an elastomeric material, the latter is subjected to a certain amount of wear. The wear is particularly great if aggressive process gases are used in the course of vacuum processes, for example in the semiconductor industry.

A seal arrangement of the type mentioned at the outset is disclosed in JP 2008075680 A. A resilient plate is arranged on a carrying body and is sealed off from the carrying body by a seal and connected to the carrying body by screwing, for example. The portion of the plate protruding from the carrying portion forms a bending portion and is bent when the vacuum valve is closed. An elastomeric sealing material is arranged on the bending portion.

In the seal arrangement known from DE 31 30 653 A1, a valve plate, which forms a carrying portion, has a membrane-like spring adjacent to its radially outer edge portion, which spring is curved in different directions in the manner of a corrugated bellows. The spring is adjoined by a solid outer ring, which carries a sealing ring made of an elastomeric sealing material.

### SUMMARY

The object of the invention is to make available a seal arrangement that is of the type mentioned at the outset and that has advantageous properties. This is achieved by a seal arrangement having one or more features of the invention.

In the seal arrangement according to the invention, the first component has a carrying portion and a bending portion. In this case, the elastomeric sealing material can be arranged on the bending portion and the sealing surface can be arranged on the second component. Alternatively, the sealing surface can be arranged on the bending portion and the elastomeric sealing material can be arranged on the second component. The bending portion has a thickness measured in the pressing-on direction, which thickness, in the case of the elastomeric sealing material being arranged on the bending portion without taking into account the elastomeric sealing material, is less than one third, preferably less than one fifth, of a thickness of the carrying portion measured in the pressing-on direction.

Advantageously, the thickness of the bending portion, in the case of the elastomeric sealing material being arranged on the bending portion without taking into account the sealing material, is, over the entire extent of the bending portion, less than one third, preferably less than one fifth, of the thickness of the carrying portion measured in the pressing-on direction, over the entire extent of the carrying portion. In other words, the maximum thickness of the bending portion (without taking into account the elastomeric sealing material, if the latter is arranged on the bending portion) is less than one third of the minimum thickness of the carrying portion, in each case with respect to the pressing-on direction.

In this way, a seal arrangement can be easily formed in which a bending portion is provided that has the elastomeric sealing material or the sealing surface and that is more easily bendable than the carrying portion. Advantageously, with respect to the pressing-on force, the flexural strength of the bending portion can be less than one third, preferably less than one fifth, of the flexural strength of the carrying portion.

The elastomeric sealing material has a thickness of less than 0.8 mm, preferably of less than 0.4 mm, measured in the pressing-on direction. In this way, the surface area of the elastomeric sealing material exposed to aggressive process gases can be reduced, such that wear caused by such aggressive process gases is reduced. Moreover, the extent by which the elastomeric sealing material is compressed during the closing of the seal arrangement, measured in the pressing-on direction, can be reduced. This likewise reduces the wear of the elastomeric sealing material. In addition, it is thereby possible to reduce the production of particles during the closing and opening of the seal.

In order to achieve an advantageous flexibility of the bending portion, provision is made that the thickness of the bending portion, measured in the pressing-on direction, is, over its entire extent, less than ⅕, preferably less than ⅛, of the length of the bending portion, wherein the length of the bending portion is in relation to a longitudinal central section of the seal arrangement lying parallel to the pressing-on direction, i.e. that the length of the bending portion is measured in this longitudinal central section. This preferably applies to each longitudinal central section through the seal arrangement.

Tolerances in the dimensions and/or changes in the geometry, e.g. on account of thermal expansion, can be compensated at least for the most part by the bending portion in the design according to the invention. In seal arrangements according to the prior art, the elastomeric sealing material makes a considerable contribution to compensating for such tolerances and/or changes in geometry. By contrast, in a seal arrangement according to the invention, the elastomeric sealing material can be designed to compensate only to a (considerably) lesser extent for such tolerances and/or changes in geometry. It is thus made possible in particular that the elastomeric sealing material, compared to seal arrangements according to the prior art, has a smaller thickness measured in the pressing-on direction.

The bending portion is formed integrally with the carrying portion. By virtue of the design according to the invention, no additional sealing element is needed between the bending portion and the carrying portion. The invention leads to a seal arrangement that is easy to produce and assemble, is highly reliable in operation and has a very long useful life. Maintenance work can be reduced by comparison with conventional seal arrangements.

The carrying portion as a whole can be formed in one piece.

To be able to sufficiently compensate for component tolerances and/or changes in geometry (e.g. due to temperature changes), the contact region of the bending portion in the sealed state of the first and second components is deflected, in relation to the separated state of the first and second components, by at least 0.1 mm, preferably at least 0.2 mm, by a bending of the bending portion. Depending on the particular use, this deflection can also be greater, for example more than 0.4 mm. In an advantageous embodiment of the invention, with respect to a longitudinal central section through the first bending part parallel to the pressing-on direction, and preferably for each such longitudinal central section, the change of the curvature of the bending portion between the separated state and the sealed state of the first and second components is more than three times as great, preferably more than five times as great, as the corresponding change of the curvature of the carrying portion.

In a seal arrangement according to the invention, a relatively low sealing force can advantageously be used. Thus, in the sealed state of the first and second components, the sealing force acting per unit length of the seal can be less than 3 N/mm, preferably less than 1 N/mm.

In the present document, a vacuum device is to be understood as meaning a device in which a pressure of less than 0.1 mbar can be present in at least one vacuum region during operation. In this document, a “vacuum-tight” seal arrangement is one which, in a space sealed off from the atmosphere by the seal arrangement and measuring 10 l for example, is able to maintain the pressure at below 0.1 mbar for one hour.

The elastomeric sealing material can in particular be fluoro rubber (FPM) or perfluoro rubber (FFPM).

The sealing surface and the surface of the elastomeric sealing material bearing thereon in the closed state of the seal arrangement can be flat. Other shapes, for example curved shapes, of the sealing surface and/or of the surface of the elastomeric sealing material are conceivable and possible. It is also conceivable and possible that the sealing surface and the surface of the elastomeric sealing material are in contact with each other in two or more regions which are spaced radially apart from one another and which each have a ring shape, for example a circular ring shape.

The bending portion can be generally flat either in the opened or in the closed state and is then curved in the other of the two states. The bending portion can also be curved both in the opened state and also in the closed state. However, a curvature of the bending portion preferably always extends only in one direction. The bending portion does not therefore have regions curved in different directions (relative to a longitudinal central section through the seal arrangement parallel to the pressing-on direction).

In each of its states, the bending portion advantageously has at each location a radius of curvature of more than 30 cm, preferably more than 50 cm, particularly preferably more than 100 cm. If the bending portion is flat in one of its states, at one location or overall, then the radius of curvature at this location or at each location is infinite in this state.

### BRIEF DESCRIPTION OF THE DRAWINGS

Further advantages and details of the invention are explained below with reference to the accompanying drawing, in which:

FIG. 1 shows a perspective view of a vacuum valve with a seal arrangement according to the invention, in a first illustrative embodiment of the invention;

FIG. 2 shows a side view of the vacuum valve from FIG. 1, in the opened state of the vacuum valve;

FIG. 3 shows a longitudinal central section through the seal arrangement along the line AA in FIG. 2;

FIG. 4 shows a view corresponding to FIG. 3, in the closed state of the vacuum valve;

FIG. 5 shows an enlarged detail B from FIG. 3 (with exaggerated curvature of the bending portion);

FIG. 6 shows an enlarged detail C from FIG. 4;

FIG. 7 and FIG. 8 show perspective views of the closure member from different viewing directions;

FIG. 9 and FIG. 10 show plan views of the side of the closure member having the elastomeric sealing material and of the opposite side of the closure member;

FIG. 11 is a graph showing an example of the spring characteristics of the elastomeric sealing material and of the bending portion;

FIG. 12 shows a possible configuration of a housing with a seal arrangement according to the invention, in a second illustrative embodiment of the invention, shown in a longitudinal central section through the seal arrangement along the line EE in FIG. 14;

FIG. 13 shows an enlarged detail from FIG. 12 in the raised state of the cover (the curvature of the bending portion has been exaggerated);

FIG. 14 shows a section along the line DD in FIG. 12;

FIG. 15 shows a further possible configuration of the seal arrangement.

Some of the figures are simplified and some highly schematic (in particular for the second illustrative embodiment).

### DETAILED DESCRIPTION

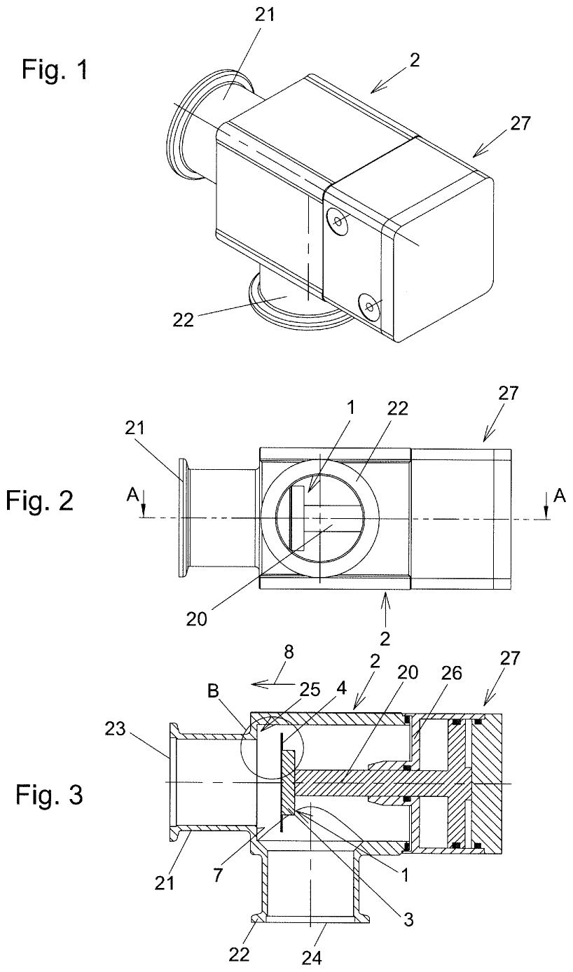

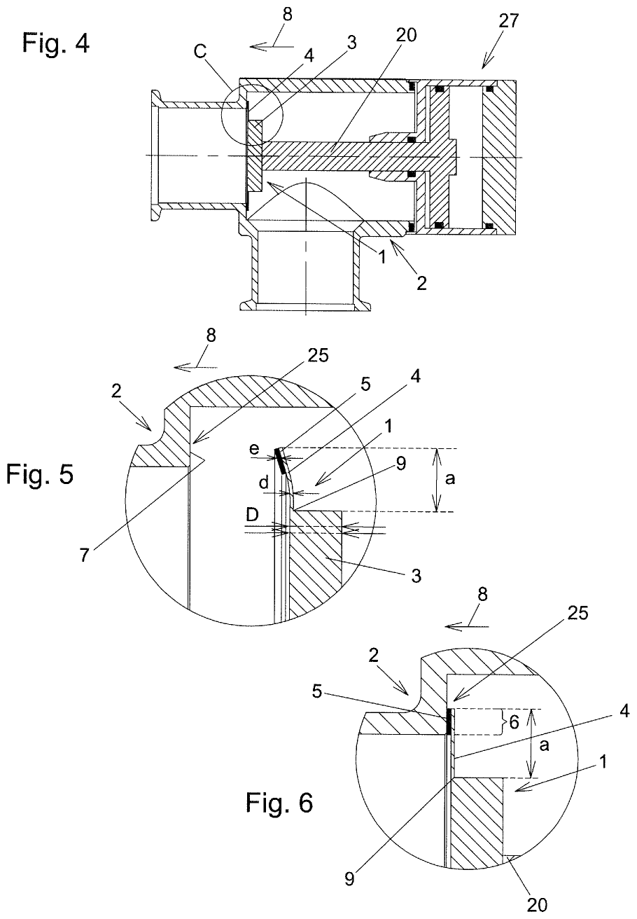

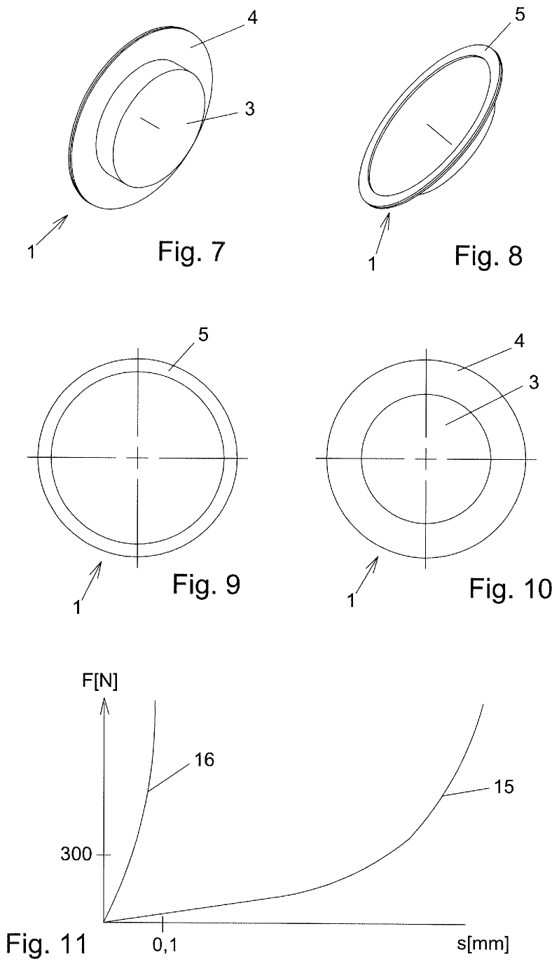

A first illustrative embodiment of a vacuum-tight seal arrangement according to the invention is explained below with reference to FIGS. 1 to 11. The seal arrangement according to the invention here forms the dynamic seal of a vacuum valve which, in the illustrative embodiment, is configured in the form of a corner valve. The seal arrangement according to the invention could equally well be used as a dynamic seal in other types of vacuum valves, for example sliding valves, L-valves, etc.

The seal arrangement comprises a first component 1, here formed by a closure member of the vacuum valve, said closure member being configured in the form of a valve plate, and a second component 2, here formed by the valve housing.

A reverse configuration is also conceivable and possible, in which the first component of the seal arrangement is formed by the valve housing and the second component of the seal arrangement is formed by the closure member.

The first component 1, formed by the closure member, has a carrying portion 3, which is mounted on a valve rod 20. For this purpose, it is possible for example to provide a screw connection (not shown in the figures). Other types of connection can also be provided, for example a clamping connection or welded connection.

The carrying portion 3 can have a plate-shaped configuration, as is the case in the present illustrative embodiment. In the illustrative embodiment, the carrying portion, seen in a plan view (seen in the pressing-on direction 8), has a circular shape (cf. FIG. 9 and FIG. 10). In other types of valves in particular, the carrying portion 3, seen in a plan view, could also have another shape, for example a rectangular shape.

The bending portion 4 of the first component 1 protrudes from the carrying portion 3. Seen in a plan view (i.e. seen in the pressing-on direction 8), the bending portion 4 surrounds the carrying portion 3 about the entire circumference thereof, i.e. it has a ring shape, specifically a circular ring shape in the illustrative embodiment.

An elastomeric sealing material 5 is arranged on the bending portion 4 in a contact region 6. A detailed description of the first component 1 is given further below.

In this illustrative embodiment, the second component 2 of the seal arrangement is formed by the valve housing and has first and second flanges 21, 22, which form first and second valve openings 23, 24. Moreover, the second component 2 has a valve seat 25 with a sealing surface 7. In the closed state of the vacuum valve, i.e. in the closed state of the seal arrangement, the elastomeric sealing material 5 is pressed via the contact region 6 onto the sealing surface 7.

In the illustrative embodiment, the cover of the valve housing is formed by the bottom 26 of a cylinder of a piston/cylinder unit 27. The piston rod of this piston/cylinder unit 27 forms the valve rod 20 of the vacuum valve, which valve rod 20 is guided, through a linear passage formed in the bottom 26, out of the interior of the valve housing, which forms a vacuum region of the vacuum valve.

By the use of the piston/cylinder unit 27, the vacuum valve can be closed and opened, i.e. the seal arrangement can be adjusted between the sealed state of the first and second components 1, 2 and the separated state of the first and second components.

In the sealed state of the first and second components 1, 2, the first component 1 is pressed onto the second component 2, in the illustrative embodiment onto the valve seat of the valve housing, with a pressing-on force that acts in a pressing-on direction 8. In the illustrative embodiment, the pressing-on force is applied by the piston/cylinder unit 27.

In the separated state of the first and second components, the first component 1 is distanced from the second component 2, that is to say, in the illustrative embodiment, lifted from the valve seat of the valve housing.

In the illustrative embodiment, the carrying portion 3 of the first component 1 is formed in one piece, although it could also be composed of several interconnected pieces. In the illustrative embodiment, the whole carrying portion 3 is made of metal, in particular steel, as is preferred. The carrying portion 3 could additionally have other materials too. However, at least a base body of the carrying portion 3, which gives the carrying portion 3 most of its stability, is expediently made of metal, in particular steel.

The bending portion 4 protrudes from the carrying portion 3. The bending portion has a plate which is ring-shaped (seen in a plan view) and on which the elastomeric sealing material 5 is applied, preferably by vulcanization. The ring-shaped plate is preferably made of metal, in particular steel.

The plate can have a circular ring shape, for example, as is shown in the illustrative embodiment. However, other ring shapes are also conceivable and possible, for example with a rectangular outer and inner border (if appropriate with rounded corners). A ring-shaped plate is generally one that is closed in the circumferential direction and has a central opening.

In the illustrative embodiment, the ring-shaped plate of the bending portion 4 is formed integrally with the generally integrally formed carrying portion 3. The bending portion and the carrying portion thus have no connection points, for example weld seams, between initially separate parts.

In another possible embodiment of the invention, the elastomeric sealing material 5 could be arranged on the valve seat 25, and the bending portion 4 could have the sealing surface. The bending portion 4 could then be made in one piece from a single material. Moreover, the first component 1 could then as a whole be formed in one piece from a single material.

The bending portion 4 is designed to bend when the first and second components 1, 2 are moved from their separated state to their sealed state. Moreover, a certain deformation of the elastomeric sealing material 5 takes place by compression, although the latter is preferably less than the flexion of the bending portion 4. By contrast, when the first component and second components 1, 2 are moved from the separated state to the sealed state, the carrying portion 3 does not bend, or at least it bends much less than the bending portion 4.

To this end, the bending portion 4 has a thickness d, measured in the pressing-on direction 8, which is less than one third, preferably less than one fifth, of a thickness D of the carrying portion 3 measured in the pressing-on direction 8. This preferably applies for the entire extent of the bending portion 4, particularly if the thickness of the bending portion 4 in the contact region 6 is measured without the elastomeric sealing material 5 (i.e. not taking into account the thickness of the elastomeric sealing material 5), and for the entire extent of the carrying portion 3. In the illustrative embodiment, the plate of the bending portion 4 coated with the elastomeric sealing material 5 has the same thickness d over its entire extent, apart from the contact region 6, and, in the contact region 6, the thickness e of the elastomeric sealing material 5 measured in the pressing-on direction 8 is added, which thickness e is less than 0.8 mm, preferably less than 0.4 mm.

Setting aside the elastomeric sealing material 5, the thickness of the bending portion 4 is expediently less than 2 mm, preferably less than 1 mm.

In the illustrative embodiment shown, the thickness of the carrying portion 3 is the same all over, although it could also change across the extent thereof. The minimum thickness of the carrying portion 3, measured in the pressing-on direction 8, is preferably at least 4 mm.

Furthermore, the thickness d of the bending portion 4 measured in the pressing-on direction 8 is expediently less than ⅕, preferably less than ⅛, of the length a of the bending portion. This value can also be smaller in practice, for example up to 1/20. In this case, the length of the bending portion is measured in a longitudinal central section through the seal arrangement, this central section being parallel to the pressing-on direction. The length measurement of the bending portion can in particular be effected in a straight line in a direction at right angles to the pressing-on direction. Since the deviation of the bending portion from a course at right angles to the pressing-on direction is slight, the difference from an exact measurement of the length of the bending portion along the exact course of the bending portion is negligible.

The bending portion 4 is generally designed such that the contact region of the bending portion in the sealed state of the first and second components 1, 2 is deflected, in relation to the separated state of the first and second components 1, 2, by a bending of the bending portion 4, by at least 0.1 mm, relative to the pressing-on direction 8, in relation to the region 9 in which the bending portion 4 starts protruding from the carrying portion 3. That is to say, the relative position of the contact region of the bending portion 4 changes by this amount in relation to the region 9 in which the bending portion 4 starts protruding from the carrying portion 3. This deflection is preferably at least 0.2 mm. Depending on the particular use, greater values of this deflection are also possible, e.g. at least 0.4 mm.

FIG. 5 shows the bending portion in the opened state and curved (with the curvature greatly exaggerated) and FIG. 6 shows it in the closed state and flat. Various modifications to this are conceivable and possible, for example less curved in the closed state than in the opened state, or flat in the opened state and curved in the opposite direction in the closed state.

By contrast, between the region in which the bending portion 4 protrudes from the carrying portion 3 and the region in which the carrying portion 3 is supported, i.e. mounted on the valve rod 20 in the illustrative embodiment, there is barely any deflection of the carrying portion 3 during the closing of the seal arrangement. The extent of such a deflection is preferably below 0.05 mm, particularly preferably below 0.03 mm.

The reduction of the thickness e of the elastomeric sealing material 5 measured in the pressing-on direction 8, in the sealed state of the first and second components 1, 2 compared to the separated state of the first and second components 1, 2, can be less than 0.3 mm, preferably less than 0.2 mm, particularly preferably less than 0.1 mm.

The sealing force needed to reach the sealed state between the first and second components can be relatively small here, for example even less than 1 N/mm.

As regards the degrees of flexural stiffness, the flexural stiffness of the bending portion 4 is preferably less than one third of the flexural stiffness of the carrying portion 3, particularly preferably less than one fifth.

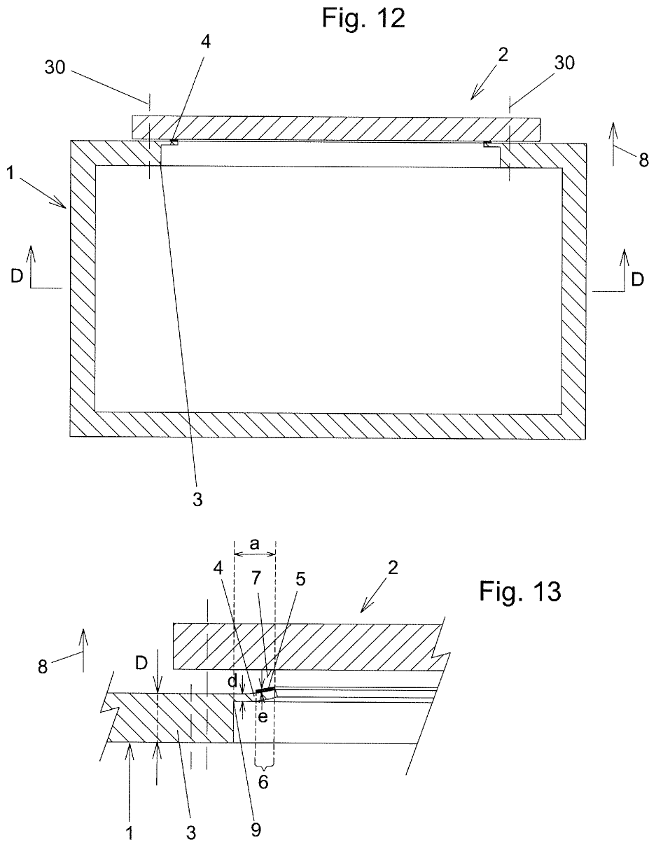

In FIG. 11, the curve 15 shows an example of the force F that has to act in the pressing-on direction 8 in order to obtain a deflection of the contact region 6 of the bending portion 4 in relation to the region 9 in which the bending portion 4 protrudes from the carrying portion 3. The extent s of this deflection is plotted in millimeters. The force F with which the first component 1 is pressed in the pressing-on direction 8 against the second component 2 is indicated in Newtons. The curve 16 shows the corresponding force that has to act in the pressing-on direction 8 in order to press in the elastomeric sealing material 5 across its entire contact area (by an extent s). It is clear that the spring constant for the elastomeric sealing material 5 is much greater than for the bending portion 4. If one considers a state for a spring excursion (extent s) of more than 0.03 mm, the spring constant of the elastomeric sealing material 5 is at any rate more than three times as great as the spring constant of the bending portion 4.

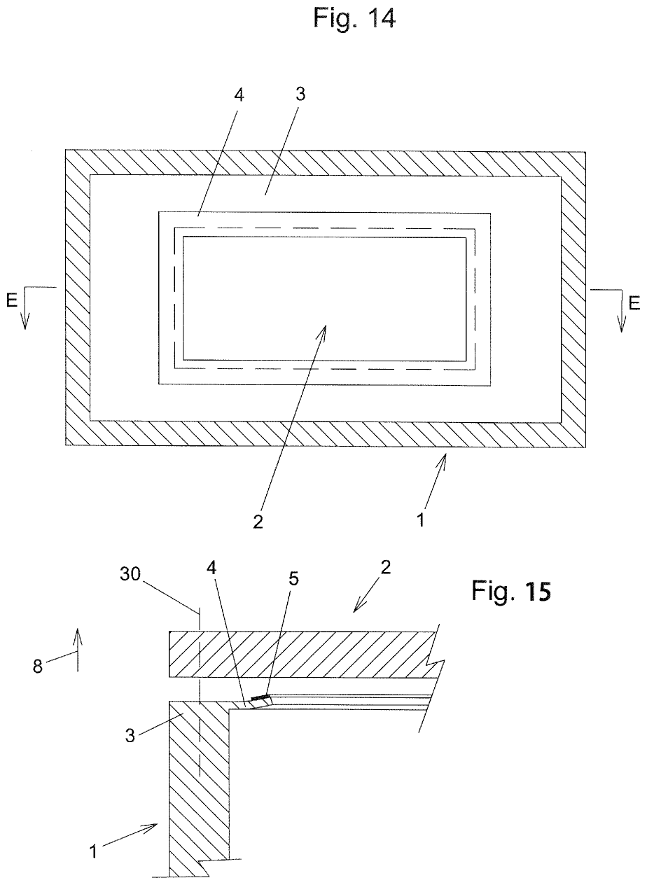

A second illustrative embodiment of the invention is shown in FIGS. 12 to 14. Parts of the seal arrangement that are analogous to the first illustrative embodiment are labeled with the same reference signs as in the first illustrative embodiment.

The seal arrangement according to the invention is here configured as a static seat A housing is schematically shown, its cover being sealed off from a lower part by this seal arrangement. It can be in the form of a vacuum chamber for example, wherein flanges of the vacuum chamber have been omitted in the figure for the sake of simplicity. Instead of this, it could be a valve housing of a vacuum valve for example (of which the valve openings and other elements of the valve housing are not shown). For example, apart from the configuration of the static seal, the valve housing could be configured according to the valve housing of the first illustrative embodiment. The seal arrangement according to the invention could also be used as a static seal in other vacuum applications.

The seal arrangement comprises a first component 1, here formed by the lower part of the housing, and a second component 2, here formed by the cover of the housing. The reverse configuration is also conceivable and possible, in which the cover of the housing forms the first component of the seal arrangement and the lower part of the housing forms the second component of the seal arrangement.

The first component 1 has a bending portion 4 which protrudes from a carrying portion 3. The latter is formed by a portion of the wall of the lower part of the housing adjoining the bending portion 4. In this portion of the wall, the connection is also made to the second component 2 by screw connections 30, which are indicated by dashed lines. In the illustrative embodiment, the carrying portion is formed by the wall lying parallel to the cover, which wall has the opening that is sealed off by the cover.

In the illustrative embodiment, the carrying portion 3 is formed in one piece, although it could also be composed of several interconnected pieces. In the illustrative embodiment, the whole carrying portion 3 is made of metal, in particular steel, as is preferred. The carrying portion 3 could additionally have other materials too. However, at least a support body of the carrying portion 3, which gives the carrying portion 3 most of its stability, is expediently made of metal, in particular steel.

The bending portion 4 of the first component 1 protrudes from the carrying portion 3. Seen in a plan view (i.e. seen in the pressing-on direction 8), the bending portion 4 surrounds the carrying portion 3 about the entire circumference thereof, i.e. it has a ring shape, specifically with a rectangular contour in the illustrative embodiment.

An elastomeric sealing material 5 is arranged on the bending portion 4 in a contact region 6.

The bending portion 4 protruding from the carrying portion 3 has a plate which is ring-shaped (=closed in the circumferential direction and having a central opening), in the illustrative embodiment with a rectangular contour as seen in a plan view, and on which the elastomeric sealing material 5 is applied, preferably by vulcanization. The ring-shaped plate is preferably made of metal, in particular steel. In other illustrative embodiments, the ring-shaped plate could have another contour seen in a plan view, for example a circular ring-shaped contour.

In the illustrative embodiment, the ring-shaped plate of the bending portion 4 is formed integrally with the generally integrally formed carrying portion 3. The bending portion and the carrying portion thus have no connection points, for example weld seams, between initially separate parts.

By the screw connection 30, the seal arrangement is closed, i.e. the sealed state of the first and second components 1, 2 is produced. If the screw connection 30 is opened and the second component 2 is removed from the first component 1, the seal arrangement is opened.

In the sealed state of the first and second components 1, 2, the first component 1 is pressed onto the second component 2 via the contact region 6, with a pressing-on force that acts in the pressing-on direction 8. In this case, the elastomeric sealing material 5 is pressed against a sealing surface 7 arranged on the second component 2. In this illustrative embodiment, the pressing-on force is applied by the screw connection 30.

In the separated state of the first and second components 1, 2, the first component 1 is distanced from the second component 2. The separated state is shown in FIG. 13.

In a modified embodiment, the elastomeric sealing material 5 could be arranged on the second component 2 and the bending portion 4 could have the sealing surface. The bending portion 4 could then be formed in one piece from a single material.

The bending portion 4 is designed to bend when the first and second components 1, 2 are moved from their separated state to their sealed state. Moreover, a certain deformation of the elastomeric sealing material 5 takes place by compression, although the latter is preferably less than the flexion of the bending portion 4. By contrast, when the first and second components 1, 2 are moved from the separated state to the sealed state, the carrying portion 3 does not bend, or at least it bends much less than the bending portion 4.

To this end, the bending portion 4 has a thickness d, measured in the pressing-on direction 8, which is less than one third, preferably less than one fifth, of a thickness D of the carrying portion 3 measured in the pressing-on direction 8. This preferably applies for the entire extent of the bending portion 4, particularly if the thickness of the bending portion 4 is measured without the elastomeric sealing material 5 (i.e. not taking into account the thickness of the elastomeric sealing material 5), and for the entire extent of the carrying portion 3. In the illustrative embodiment, the plate of the bending portion 4 coated with the elastomeric sealing material 5 has the same thickness d over its entire extent, apart from the contact region 6, and, in the contact region 6, the thickness e of the elastomeric sealing material 5 measured in the pressing-on direction 8 is added, which thickness e is less than 0.8 mm, preferably less than 0.4 mm.

Setting aside the elastomeric sealing material 5, the thickness of the bending portion 4 is expediently less than 2 mm, preferably less than 1 mm.

In the illustrative embodiment shown, the thickness of the carrying portion 3 is the same all over, although it could also change across the extent thereof. The minimum thickness of the carrying portion 3, measured in the pressing-on direction 8, is preferably at least 4 mm.

Furthermore, the thickness d of the bending portion 4 measured in the pressing-on direction 8 is expediently less than ⅕, preferably less than ⅛, of the length a of the bending portion, relative to the longitudinal central section lying parallel to the pressing-on direction. This value can also be smaller in practice, for example up to 1/20. In this case, the length of the bending portion is measured in a longitudinal central section through the seal arrangement, this central section being parallel to the pressing-on direction. The length measurement of the bending portion can in particular be effected in a straight line in a direction at right angles to the pressing-on direction. Since the deviation of the bending portion from a course at right angles to the pressing-on direction is slight, the difference from an exact measurement of the length of the bending portion along the exact course of the bending portion is negligible.

The bending portion 4 is generally designed such that the contact region of the bending portion in the sealed state of the first and second components 1, 2 is deflected, in relation to the separated state of the first and second components 1, 2, by a bending of the bending portion 4 by at least 0.1 mm, relative to the pressing-on direction 8, in relation to the region 9 in which the bending portion 4 starts protruding from the carrying portion 3. That is to say, the relative position of the contact region of the bending portion 4 changes by this amount with respect to a region in which the bending portion 4 starts protruding from the carrying portion 3. This deflection is preferably at least 0.2 mm. Depending on the particular use, greater values of this deflection are also possible, e.g. at least 0.4 mm.

FIG. 13 shows the bending portion in the opened state and curved (with the curvature greatly exaggerated) and FIG. 12 shows it in the closed state and flat. Various modifications to this are conceivable and possible, for example less curved in the closed state than in the opened state, or flat in the opened state and curved in the opposite direction in the closed state.

By contrast, between the region in which the bending portion 4 protrudes from the carrying portion 3 and the region in which the carrying portion 3 is supported, i.e. mounted on the vertical wall of the vacuum chamber in the illustrative embodiment, there is barely any deflection of the carrying portion 3 during the closing of the seal arrangement. The extent of such a deflection is preferably below 0.05 mm, particularly preferably below 0.03 mm.

The reduction in the thickness e of the elastomeric sealing material 5 measured in the pressing-on direction 8, in the sealed state of the first and second components 1, 2 compared to the separated state of the first and second components 1, 2, can be less than 0.3 mm, preferably less than 0.2 mm, particularly preferably less than 0.1 mm.

The sealing force needed to reach the sealed state between the first component and the second component can be relatively small here, for example even less than 1 N/mm.

As regards the degrees of flexural stiffness, the flexural stiffness of the bending portion 4 is preferably less than one third of the flexural stiffness of the carrying portion 3, particularly preferably less than one fifth.

As regards the spring constants of the bending portion 4 and of the elastomeric sealing material 5, reference is once again made to FIG. 11. The observations made regarding FIG. 11 in connection with the first illustrative embodiment also apply identically to the second illustrative embodiment.

FIG. 15 shows a highly schematic view, analogous to FIG. 13, of a modification of the second illustrative embodiment. Here, the bending portion 4 issues directly from the end of the wall of the housing standing at right angles to the cover. The carrying portion 3 is thus formed by the end portion of this wall, for example the vertical walls of the lower part of the housing. Apart from this difference, the observations made concerning the second illustrative embodiment apply analogously here, and reference is made to these observations.

In the illustrative embodiments described above, the bending portion 4 is bent as a whole during the closing of the seal arrangement. By contrast, the bending portion 4 could also be designed, for example, to be bendable only in its region adjoining the carrying portion and otherwise to be much less bendable (i.e. to have a higher flexural strength, preferably a flexural strength at least three times as great). In the opened state of the seal arrangement, the bending portion could then be designed rectilinearly adjacent to the relatively short and more bendable region (seen in the longitudinal central section through the seal arrangement).

### KEY TO THE REFERENCE NUMBERS

1 first component

2 second component

3 carrying portion

4 bending portion

5 elastomeric sealing material

6 contact region

7 sealing surface

8 pressing-on direction

9 region

15 curve

16 curve

20 valve rod

21 flange

22 flange

23 valve opening

24 valve opening

25 valve seat

26 bottom

27 piston/cylinder unit

30 screw connection

1. A seal arrangement for sealing first and second components of a vacuum device, the seal arrangement comprising:
an elastomeric sealing material arranged on one of the two components that interacts with a sealing surface arranged on the other of the two components, wherein, in a sealed state of the first and second components, the first component is pressed onto the second component with a pressing-on force which acts in a pressing-on direction, and the sealing material bears on the sealing surface in a contact region, and, in a separated state of the first and second components, the elastomeric sealing material is spaced apart from the sealing surface;
the first component has a carrying portion and a bending portion, and the elastomeric sealing material is arranged on the bending portion and the sealing surface is arranged on the second component, or the sealing surface is arranged on the bending portion and the elastomeric sealing material is arranged on the second component, and,
a thickness of the bending portion measured in the pressing-on direction, in the case of the elastomeric sealing material being arranged on the bending portion without taking into account the elastomeric sealing material, is less than one third of a thickness of the carrying portion measured in the pressing-on direction, the thickness of the bending portion measured in the pressing-on direction is, over its an entire extent thereof, less than one fifth of the length of the bending portion, and the length of the bending portion is measured in a longitudinal central section through the seal arrangement, this central section being parallel to the pressing-on direction;
the bending portion is formed in one piece with the carrying portion and the elastomeric sealing material has a maximum thickness of less than 0.8 mm, measured in the pressing-on direction.

2. The seal arrangement as claimed in claim 1, wherein the thickness of the bending portion measured in the pressing-on direction, in the case of the elastomeric sealing material being arranged on the bending portion without taking into account the elastomeric sealing material, is less than one fifth of the thickness of the carrying portion measured in the pressing-on direction.

3. The seal arrangement as claimed in claim 1, wherein, in relation to a longitudinal central section extending through the first component parallel to the pressing-on direction, the a change of the curvature of the bending portion between the separated state and the sealed state of the first and second components is more than three times as great as the a change of the curvature of the carrying portion between the separated state and the sealed state of the first and second components.

4. The seal arrangement as claimed in claim 1, wherein the elastomeric sealing material has a maximum thickness of less than 0.4 mm, measured in the pressing-on direction.

5. The seal arrangement as claimed in claim 1, wherein the thickness of the bending portion measured in the pressing-on direction is, over the entire extent thereof, less than one eighth of the length of the bending portion, and the length of the bending portion is measured in a longitudinal central section through the seal arrangement, this central section being parallel to the pressing-on direction.

6. The seal arrangement as claimed in claim 1, wherein the thickness of the bending portion measured in the pressing-on direction is less than 2 mm.

7. The seal arrangement as claimed in claim 1, wherein the contact region of the bending portion in the sealed state of the first and second components is deflected, in relation to the separated state of the first and second components, by the bending of the bending portion by at least 0.1 mm relative to the pressing-on direction, in relation to a region of the bending portion in which the bending portion starts protruding from the carrying portion.

8. The seal arrangement as claimed in claim 1, wherein, in the sealed state of the first and second components, the pressing-on force acting per unit length of the elastomeric sealing material is less than 3 N/mm.

9. The seal arrangement as claimed in claim 1, wherein, in the sealed state of the first and second components, the pressing-on force acting per unit length of the elastomeric sealing material is less than 1 N/mm.

10. The seal arrangement as claimed in claim 1, wherein, at least starting from a spring excursion of the elastomeric sealing material of 0.03 mm, the a spring constant of the elastomeric sealing material is at least three times as great as a spring constant of the bending portion.

11. The seal arrangement as claimed in claim 1, wherein a flexural strength of the bending portion is less than one third of the a flexural strength of the carrying portion.

12. The seal arrangement as claimed in claim 11, wherein the flexural strength of the bending portion is less than one fifth of the flexural strength of the carrying portion.

13. A vacuum valve with comprising a closure member which, in the a closed state of the vacuum valve, is pressed onto a valve seat and, in the an opened state of the vacuum valve, is lifted from the valve seat, and the closure member, in the closed state of the vacuum valve, is sealed off from the valve seat by the seal arrangement as claimed in claim 1.

14. The vacuum valve as claimed in claim 13, wherein the first component of the seal arrangement forms the closure member, and the second component of the seal arrangement forms a valve housing having the valve seat, or the second component of the seal arrangement forms the closure member, and the first component of the seal arrangement forms the valve housing having the valve seat.

15. A housing of a vacuum device, the housing comprising first and second components which are sealed off by the seal arrangement as claimed in claim 1.
